(19) United States
(12) Patent Application Publication
(10) Pub. No.: US 2008/0301465 A1
(43) Pub. Date: Dec. 4, 2008

(54) PROTECTION OF SOFTWARE TRANSMITTED OVER AN UNPROTECTED INTERFACE

(75) Inventors: Shaheen Gandhi, Seattle, WA (US); Clifford Garrett, Mercer Island, WA (US); Ling Tony Chen, Bellevue, WA (US); Matthew Morris, Seattle, WA (US)

Correspondence Address: WOODCOCK WASHBURN LLP (MICROSOFT CORPORATION), CIRA CENTRE, 12TH FLOOR, 2929 ARCH STREET, PHILADELPHIA, PA, 19104-2891, US

(73) Assignee: Microsoft Corporation, Redmond, WA (US)

(21) Appl. No.: 11/757,790

(22) Filed: Jun. 4, 2007

(51) Int. Cl. G06F 17/00; H04L 9/14

(52) U.S. Cl. 713/189; 380/30

(57) ABSTRACT

The same level of protection and ability to associate rights to media content available with a stand alone media player is provided with a software media player. In an example configuration, a peripheral device comprising an optical disc drive capable of reading HD DVD media, and comprising a flash memory microcontroller with cryptographic capabilities, is coupled to a host game console via a universal serial bus (USB) interface. Media content from the peripheral device is rendered on the host game console. Software protection and management are provided utilizing various cryptographic keys and protocols. Software protection and management meets the prescribed rules of the Advanced Access Content System (AACS) license agreement with respect to consumer electronics players while allowing the playback of media content (e.g., movies) to be performed by software.

### TECHNICAL FIELD

The technical field relates generally to computer processing and more specifically to computer processing security.

### BACKGROUND

A media player is a product that has the ability to playback media content. Most media players fall into one of two categories: consumer electronics media players or software media players. Consumer electronics media players are standalone players (e.g., a DVD player) that can play back content with the addition of an audio/video system. Software media players require a processor, such as personal computer, to provide software thereto.

Digital rights management (DRM) systems have been implemented to protect media content and to associate rights with media content. A known DRM scheme is the Advanced Access Content System (AACS) DRM. The AACS DRM is a digital rights management scheme for the protection of high definition movie content. For example, HD DVD and Blu-Ray Disc technologies use the AACS DRM. The AACS DRM utilizes various keys to protect and associate rights with content. These keys are often incorporated in the media player. A problem however, with utilizing a DRM scheme such as the AACS DRM with software media players is that, due to the vulnerability of the unprotected interface between the software media player and the processor, the keys are susceptible to compromise.

### SUMMARY

This Summary is provided to introduce a selection of concepts in a simplified form that are further described below in the Detailed Description Of Illustrative Embodiments. This Summary is not intended to identify key features or essential features of the claimed subject matter, nor is it intended to be used to limit the scope of the claimed subject matter.

Software media players are provided protection and rights management afforded stand alone media players. In an example embodiment, software protection and management meets the prescribed rules of the Advanced Access Content System (AACS) license agreement with respect to consumer electronics players while allowing the playback of media content (e.g., movies) to be performed by software. Thus, the ability to provide a consumer electronics experience with a software player is achievable among any currently licensed and generally available HD DVD or Blu-Ray Disc player product.

In an example configuration, a peripheral device comprising an optical disc drive capable of reading HD DVD media, and comprising a flash memory microcontroller with cryptographic capabilities, is coupled to a host console via a universal serial bus (USB) interface. The flash memory microcontroller comprises an implementation of AES-256 (Advanced Encryption Standard-256) encryption and decryption algorithms. The controller also comprises a secret AES-256 key (Kbr, boot ROM key). Additionally, the microcontroller contains an internal boot read only memory (boot ROM). This boot ROM contains instructions to perform AES-256 decryption of extra instructions in the form of firmware when the microcontroller is first powered using Kbr. The firmware is stored, encrypted, at a known position in flash memory.

A portion of Kbr is used in conjunction with AES-128 encrypt and decrypt algorithms to protect another portion of flash memory. This portion of memory contains two AES-128 keys: Ke and Ku. Both Ke and Ku are unique to each peripheral device. Ke is used in an authentication protocol between the device and software. Ku is used to further protect another portion of flash memory. This other portion of flash memory contains the encrypted device and sequence keys (e.g., AACS Device Keys and Sequence Keys). The device and sequence keys can be leveraged and/or accessed by software. In an example embodiment, the device and sequence keys are leveraged/accessed after the software that is performing an operation has authenticated itself to the peripheral device.

In this example configuration, the remainder of the unprotected flash memory is reserved for a software file system for storing software that executes on the host console. A portion of software is unique to each player device. When HD DVD movie content is detected as present in the optical disc drive by previously running console software, the player software stored in the unprotected flash memory replaces the software running on the console. The unique portion of software then authenticates itself to the device to leverage or access the device and sequence keys.

### BRIEF DESCRIPTION OF THE DRAWINGS

The foregoing summary, as well as the following detailed description, is better understood when read in conjunction with the appended drawings. For the purpose of illustrating protection of software transmitted over an unprotected interface, there is shown in the drawings exemplary constructions thereof, however, protection of software transmitted over an unprotected interface is not limited to the specific methods and instrumentalities disclosed.

FIG. 1 is an example block diagram of a system configured to implement protection of software transmitted over an unprotected interface.

FIG. 2 a flow diagram of an example process for protecting software transmitted over an unprotected interface.

FIG. 3 is a continuation of FIG. 2.

FIG. 4 is a block diagram of an example game console via which protection of software transmitted over an unprotected interface can be implemented.

FIG. 5 is a depiction of a suitable computing environment in which protection of software transmitted over an unprotected interface can be implemented.

### DETAILED DESCRIPTION OF ILLUSTRATIVE EMBODIMENTS

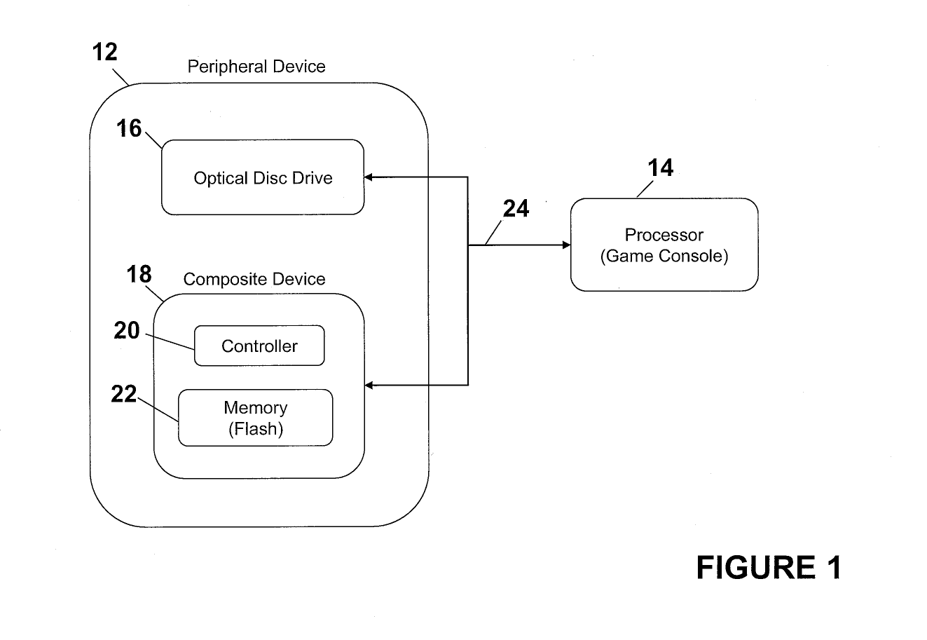

FIG. 1 is an example block diagram of a system configured to implement protection of software transmitted over an unprotected interface. Depicted in FIG. 1 is an example peripheral device 12 and an example processor 14. The peripheral device 12 comprises an optical disk drive 16 and a composite device 18. The composite device 18 comprises a controller 20 and a memory portion 22. In an example embodiment the controller 20 is in a microcontroller and the memory portion 22 comprises a flash memory portion. The memory portion 22 can comprise any appropriate storage means, such as flash memory, semiconductor memory, magnetic memory, optical memory, bubble memory, or a combination thereof for example.

The processor 14 can comprise any appropriate processor that is configured to interface with the peripheral device 12. An example processor 14 includes, but is not limited to, a general purpose processor, a desk top computer, a server, a portable entertainment device, a portable media player, e.g., a portable music player, such as an MP3 player, a walkmans, etc., a portable computing device, such as a laptop, a personal digital assistant (“PDA”), a portable phone, such as a cell phone or the like, a smart phone, a video phone, a portable email device, a thin client, a portable gaming device, etc., consumer electronic devices, such as TVs, DVD players, set top boxes, monitors, displays, etc., a public computing device, such as a kiosk, an in-store music sampling device, an automated teller machine (ATM), a cash register, etc., a navigation device whether portable or installed in-vehicle, a non-conventional computing device, such as a kitchen appliance, a motor vehicle control (e.g., steering wheel), etc., or a combination thereof. In an example embodiment, the processor 14 comprises an XBOX® 360 console and the peripheral device 12 comprises an XBOX® 360 HD DVD player coupled to the XBOX® 360 console. The peripheral device 12 and the processor 14 are coupled via interface 24. The interface 24 can comprise any appropriate interface, such as a wired interface and/or a wireless interface. In an example embodiment, the interface 24 comprises a universal serial bus (USB) interface.

The system depicted in FIG. 1 allows media content provided to the optical disc drive 16 to be played/rendered on the processor 14. It is to be understood, that the optical disc drive 16 is exemplary, and that the optical disk drive 16 represents any appropriate disc drive, such as a magnetic disc drive or the like. In an example embodiment, the media content played/rendered on the processor 14 is protected and associated with rights in accordance with a DRM scheme, such as the AACS DRM, for example.

In an example embodiment, the composite device 18 comprises software configured to implement Advanced Encryption Standard-256 (AES-256) conformant encryption and decryption. Accordingly, the controller portion 20 comprises a cryptographic boot ROM key (Kbr). In an example embodiment the boot ROM key, Kbr, is a key conforming to the AES-256. The controller portion 20 also comprises a boot routine. In an example embodiment, the boot routine is stored in read only memory, ROM, of the controller 20. The boot routine comprises instructions for decrypting software stored elsewhere (e.g., firmware) in the controller 20. In an example embodiment, the boot routine decrypts software utilizing the cryptographic key, Kbr.

In an example embodiment, the memory portion 22 comprises an authentication key, Ke, and a protection key, Ku. The authentication key, Ke, and protection key, Ku, are unique to each peripheral device 12. The authentication key, Ke, is utilized for authentication of software provided to the peripheral device 12. The protection key, Ku, is utilized to protect a portion of the memory portion 22. In an example embodiment, the portion of the memory portion 22 protected by the protection key, Ku, comprises device keys and sequence keys that are compliant with a DRM scheme to be utilized with software provided to the peripheral device 12. In an example embodiment, the device keys and sequence keys stored in the portion of memory portion 22 protected by the protection key, Ku, comprise device keys and sequence keys used in accordance with the AACS DRM. The memory portion 22 further has stored therein a software file system. In an example configuration, the software file system is unprotected. The software file system comprises player software that executes on the processor 14 to play/render media content. In an example embodiment, a portion of the player software is unique to each peripheral device 12.

When a disc or the like is inserted into the optical describes 16, software executing on the processor 14 detects the presence of the media stored on the inserted disc. The player software stored in the memory portion 22 of the peripheral device 12 is subsequently transferred to the processor 14 for playing/rendering the media content. In order to play/render to media content on the processor 14, the player software authenticates itself to the peripheral device 12 in order to leverage/access the device keys and sequence keys stored in the peripheral device 12.

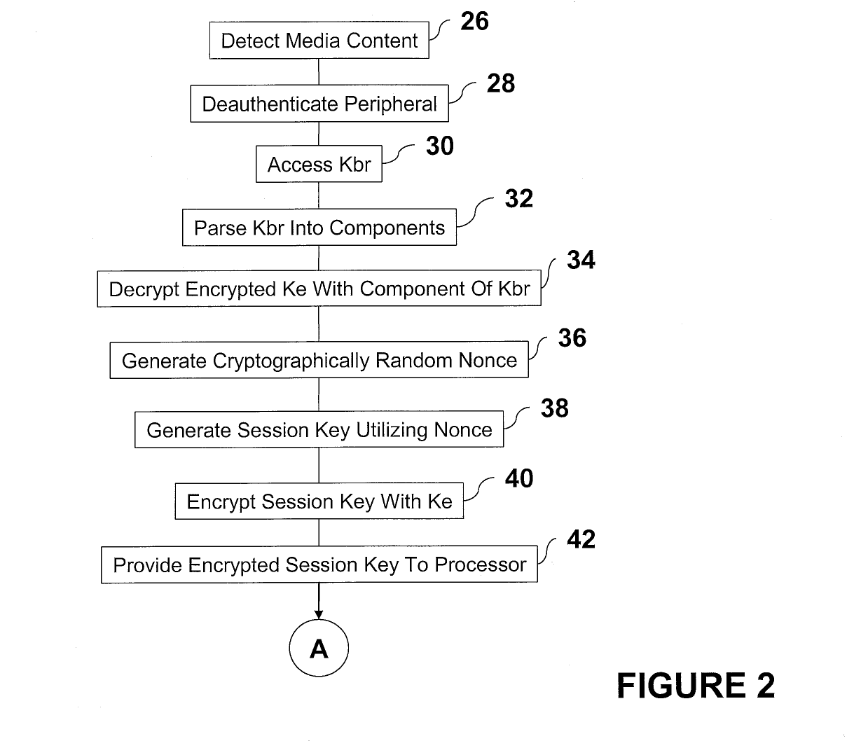

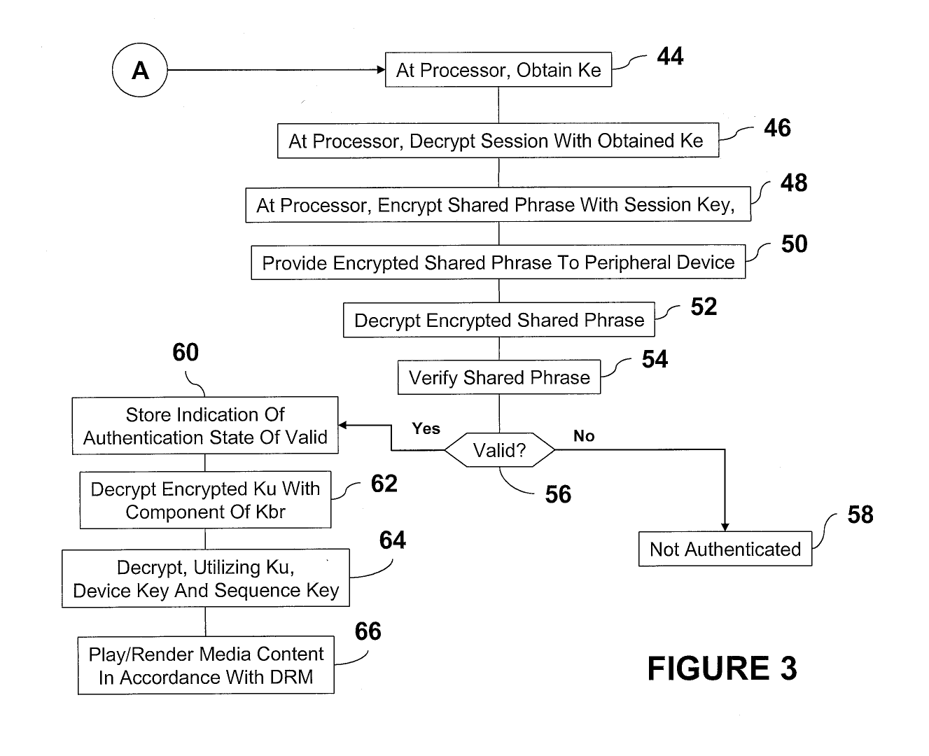

FIG. 2 and FIG. 3 depict a flow diagram of an example process for protecting software transmitted over an unprotected interface. Media content is detected at step 26. The media content may comprise, for example, content stored on an optical disc and/or magnetic disk inserted into optical describes 16. The media content can be detected by any appropriate means such as, for example, the software executing on the processor 14. At step 28 the media player is deauthenticated. That is, media player is not yet authenticated to the processor. At step 30, the boot ROM key, Kbr, is accessed. For example, the boot ROM key, Kbr, can be accessed in the composite device 18 of the peripheral device 12. The boot routine is decrypted at step 30 with the boot ROM key, Kbr. The boot ROM key, Kbr, is parsed into components at step 32. The boot ROM key, Kbr, can be parsed into any appropriate number of components. For example, Kbr can be parsed into a single component (i.e., the component is equal to Kbr), or multiple components. In an example embodiment, Kbr is parsed into two components. In an example embodiment, the boot ROM key, Kbr, is parsed into two equal size components. For example, the boot ROM key, Kbr, can comprise 256 bits and each component can comprise 128 bits. The authentication, Ke, is stored in encrypted form on the peripheral device. In an example embodiment, one of the components of Kbr is utilized as a cryptographic key. The authentication key, Ke, is decrypted with a component of Kbr at step 34. For example, the authentication key, Ke, could previously have been encrypted with a first half of Kbr comprising 128 bits. At step 34, the authentication key, Ke, would be decrypted using the first 128 bits of Kbr.

A cryptographically random nonce is generated at step 36. The cryptographically random nonce can be generated in accordance with any appropriate means. The cryptographically random nonce is utilized to generate a session key at step 38. The session key can be generated in accordance with any appropriate means. For example, the session key can be equal to (the same as) the cryptographically random nonce, the session can be an encrypted version of the cryptographically random nonce, the session key can be generated utilizing an obfuscated cryptographically random nonce, or a combination thereof. The session key is encrypted with the authentication key, Ke, at step 40. The encrypted session key is provided to the processor at step 42.

Referring now to FIG. 3, which is a continuation of FIG. 2, at step 44, an authentication key, Ke, is obtained at the processor. The authentication key obtained by the processor (obtained key) can be obtained from memory in the processor, can be accessed by the processor, or a combination thereof. Additionally, the obtained authentication key can be obfuscated in accordance with any appropriate obfuscation technique or techniques. At step 46, the received encrypted session key (received by the processor) is decrypted (by the processor) using the obtained authentication key, Ke. If the obtained authentication key and the received authentication are not identical, the peripheral device will ultimately not be authenticated. At the processor, a shared phrase is encrypted with the session key, at step 48. The shared phrase can be any appropriate phrase shared by the processor in the peripheral device (e.g., the processor 14 and the peripheral device 12). For example, a shared phrase can comprise a password, identifier of a user, an identifier of the processor, an identifier of the peripheral device, a randomly generated value, or a combination thereof for example.

The encrypted shared phrase is provided to the peripheral device at step 50. At step 52, the encrypted shared phrase is decrypted at the peripheral device. At step 54 the decrypted shared phrase is verified. The shared phrase can be verified in any appropriate manner such as, for example, comparing a copy of the shared phrase stored in the peripheral device with the decrypted shared phrase. At step 56, it is determined if the shared phrase is valid. If the shared phrase is not valid (e.g., the comparison indicated that the stored shared phrase did not match the decrypted shared phrase), the peripheral device is not authenticated at step 58. If the shared phrase is valid (step 56), an indication that the peripheral device is valid (the authentication state is valid) is stored in the peripheral device at step 60. Thus, the peripheral device can access the indication of validity during subsequent communication with the processor. The protection key, Ku, is stored in encrypted form on the peripheral device. The encrypted version of the protection key, Ku is decrypted, at step 62, utilizing a component of Kbr. In an example embodiment, the same component used to decrypt the encrypted Ke is used to decrypt the encrypted Ku. It is to be understood however, that any appropriate component of Kbr can be utilized to decrypt the encrypted Ku. The device key and sequence key are accessed and decrypted utilizing the protection key, Ku, at step 64. At step 66, the media content is played/rendered in accordance with the implemented DRM scheme. In an example embodiment, the implemented DRM scheme comprises the AACS DRM.

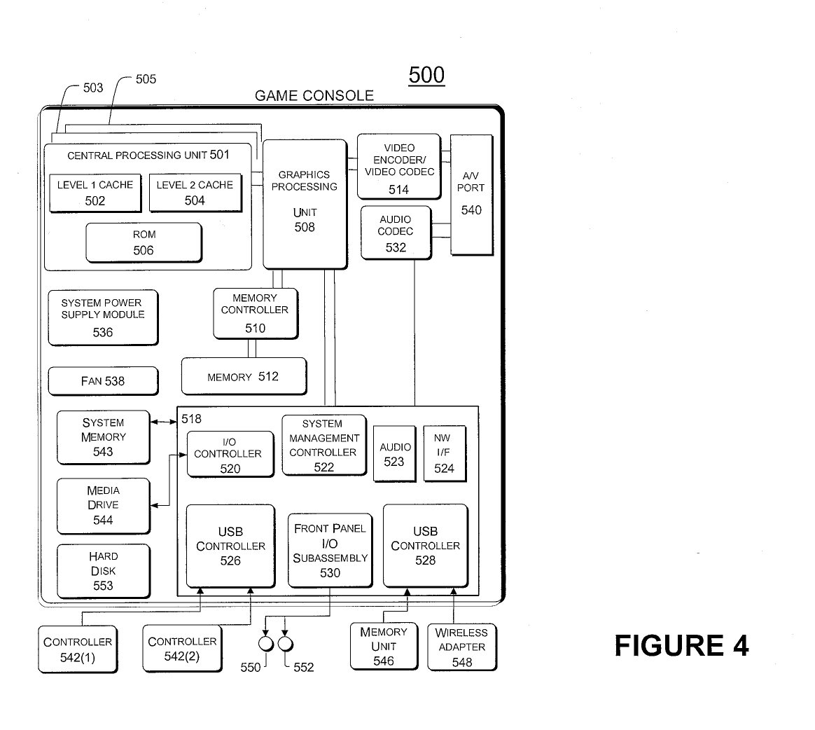

In an example scenario, the processor (e.g., processor 14) comprises a game console, such as an XBOX® game console for example. FIG. 4 is a block diagram of an example game console 500 via which protection of software transmitted over an unprotected interface can be implemented. The game console 500 along with other devices described herein, such as a display device, are capable of performing the functions needed to accomplish protection of software transmitted over an unprotected interface, as describe above. A typical game console comprises hardware and software that are specifically designed to support a core set of usage scenarios.

Game console 500 has a central processing unit (CPU) 501 having a level 1 (L1) cache 502, a level 2 (L2) cache 504, and a flash ROM (Read-only Memory) 506. The level 1 cache 502 and level 2 cache 504 temporarily store data and hence reduce the number of memory access cycles, thereby improving processing speed and throughput. The flash ROM 506 can store executable code that is loaded during an initial phase of a boot process when the game console 500 is initially powered. Alternatively, the executable code that is loaded during the initial boot phase can be stored in a FLASH memory device (not shown). Further, ROM 506 can be located separate from CPU 501. Game console 500 can, optionally, be a multi-processor system; for example game console 500 can have three processors 501, 503, and 505, where processors 503 and 505 have similar or identical components to processor 501.

A graphics processing unit (GPU) 508 and a video encoder/video codec (coder/decoder) 514 form a video processing pipeline for high speed and high resolution graphics processing. Data is carried from the graphics processing unit 508 to the video encoder/video codec 514 via a bus. The video processing pipeline outputs data to an A/V (audio/video) port 540 for transmission to a television or other display device. A memory controller 510 is connected to the GPU 508 and CPU 501 to facilitate processor access to various types of memory 512, such as, but not limited to, a RAM (Random Access Memory).

Game console 500 includes an I/O controller 520, a system management controller 522, an audio processing unit 523, a network interface controller 524, a first USB host controller 526, a second USB controller 528 and a front panel I/O subassembly 530 that may be implemented on a module 518. The USB controllers 526 and 528 serve as hosts for peripheral controllers 542(1)-842(2), a wireless adapter 548, and an external memory unit 546 (e.g., flash memory, external CD/DVD ROM drive, removable media, etc.). The network interface 524 and/or wireless adapter 548 provide access to a network (e.g., the Internet, home network, etc.) and may be any of a wide variety of various wired or wireless interface components including an Ethernet card, a modem, a Bluetooth module, a cable modem, and the like.

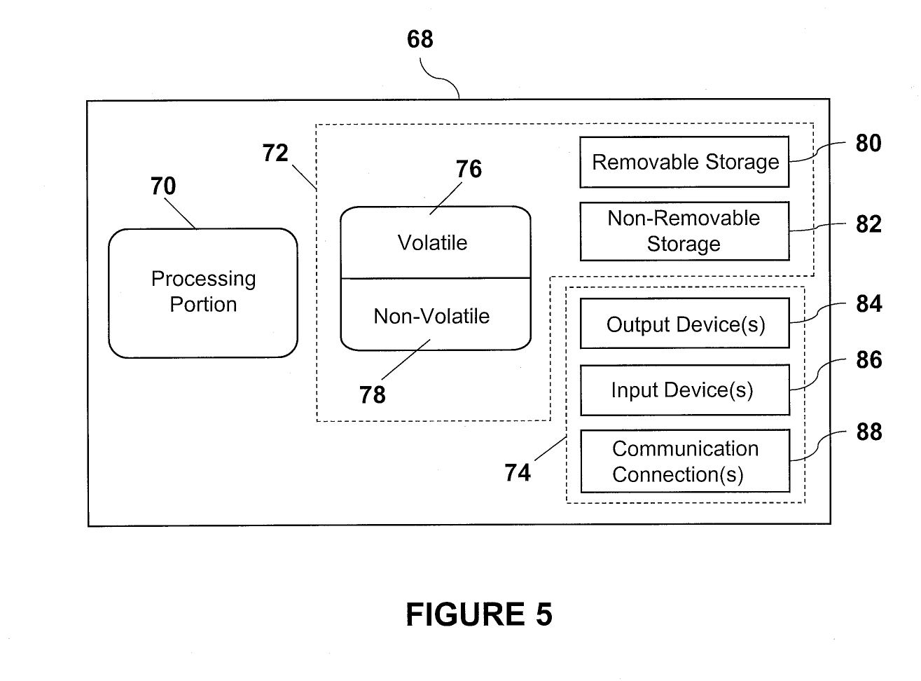

System memory 543 is provided to store application data that is loaded during the boot process. A media drive 544 is provided and may comprise a DVD/CD drive, hard drive, or other removable media drive, etc. The media drive 544 may be internal or external to the game console 500. When media drive 544 is a drive or reader for removable media (such as removable optical disks, or flash cartridges), then media drive 544 is an example of an interface onto which (or into which) media are mountable for reading. Application data may be accessed via the media drive 544 for execution, playback, etc. by game console 500. Media drive 544 is connected to the I/O controller 520 via a bus, such as a Serial ATA bus or other high speed connection (e.g., IEEE 5394). While media drive 544 may generally refer to various storage embodiments (e.g., hard disk, removable optical disk drive, etc.), game console 500 may specifically include a hard disk 552, which can be used to store game data, application data, or other types of data, and on which the file systems depicted in FIGS. 5 and 4 may be implemented.

The system management controller 522 provides a variety of service functions related to assuring availability of the game console 500. The audio processing unit 523 and an audio codec 532 form a corresponding audio processing pipeline with high fidelity, 5D, surround, and stereo audio processing according to aspects of the present subject matter described herein. Audio data is carried between the audio processing unit 523 and the audio codec 526 via a communication link. The audio processing pipeline outputs data to the A/V port 540 for reproduction by an external audio player or device having audio capabilities.

The front panel I/O subassembly 530 supports the functionality of the power button 550 and the eject button 552, as well as any LEDs (light emitting diodes) or other indicators exposed on the outer surface of the game console 500. A system power supply module 536 provides power to the components of the game console 500. A fan 538 cools the circuitry within the game console 500.

The CPU 501, GPU 508, memory controller 510, and various other components within the game console 500 are interconnected via one or more buses, including serial and parallel buses, a memory bus, a peripheral bus, and a processor or local bus using any of a variety of bus architectures.

When the game console 500 is powered on or rebooted, application data can be loaded from the system memory 543 into memory 512 and/or caches 502, 504 and executed on the CPU 501. The application can present a graphical user interface that provides a consistent user experience when navigating to different media types available on the game console 500. In operation, applications and/or other media contained within the media drive 544 may be launched or played from the media drive 544 to provide additional functionalities to the game console 500.

The game console 500 may be operated as a standalone system by simply connecting the system to a television or other display. In this standalone mode, the game console 500 may allow one or more users to interact with the system, watch movies, listen to music, and the like. However, with the integration of broadband connectivity made available through the network interface 524 or the wireless adapter 548, the game console 500 may further be operated as a participant in a larger network community.

The processor (e.g., the processor 14) can comprise a processor or combination of processors. FIG. 5 is a diagram of an exemplary processor 68 for implementing protection of software transmitted over an unprotected interface. The processor 68 comprises a processing portion 70, a memory portion 72, and an input/output portion 74. The processing portion 70, memory portion 72, and input/output portion 74 are coupled together (coupling not shown in FIG. 5) to allow communications therebetween. The input/output portion 74 is capable of providing and/or receiving components utilized to perform protection of software transmitted over an unprotected interface as described above. For example, the input/output portion 74 is capable of, as described above, providing/receiving an encrypted key, an encrypted nonce, an encrypted session key, an encrypted shared phrase, media content, or a combination thereof.

The processing portion 70 is capable of implementing protection of software transmitted over an unprotected interface as described above. For example, the processing portion 70 is capable of decrypting an encrypted authentication key with a cryptographic key, decrypting an encrypted nonce with an authentication key, decrypting an encrypted session key with an authentication key, encrypting a shared phrase, or a combination thereof.

The processor 68 can be implemented as a client processor and/or a server processor. In a basic configuration, the processor 68 can include at least one processing portion 70 and memory portion 72. The memory portion 72 can store any information utilized in conjunction with protecting software transmitted over an unprotected interface. Depending upon the exact configuration and type of processor, the memory portion 72 can be volatile (such as RAM) 76, non-volatile (such as ROM, flash memory, etc.) 78, or a combination thereof. The processor 68 can have additional features/functionality. For example, the processor 68 can include additional storage (removable storage 80 and/or non-removable storage 82) including, but not limited to, magnetic or optical disks, tape, flash, smart cards or a combination thereof. Computer storage media, such as memory portion 72, 76, 78, 80, and 82, include volatile and nonvolatile, removable and non-removable media implemented in any method or technology for storage of information such as computer readable instructions, data structures, program modules, or other data. Computer storage media include, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, universal serial bus (USB) compatible memory, smart cards, or any other medium which can be used to store the desired information and which can be accessed by the processor 68. Any such computer storage media can be part of the processor 68.

The processor 68 can also contain communications connection(s) 88 that allow the processor 68 to communicate with other devices, such as other devices, for example. Communications connection(s) 88 is an example of communication media. Communication media typically embody computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer readable media as used herein includes both storage media and communication media. The processor 68 also can have input device(s) 86 such as keyboard, mouse, pen, voice input device, touch input device, etc. Output device(s) 84 such as a display, speakers, printer, etc. also can be included.

FIG. 6 and the following discussion provide a brief general description of a suitable computing environment in which protection of software transmitted over an unprotected interface can be implemented. Although not required, various aspects of protecting software transmitted over an unprotected interface can be described in the general context of computer executable instructions, such as program modules, being executed by a computer, such as a client workstation or a server. Generally, program modules include routines, programs, objects, components, data structures and the like that perform particular tasks or implement particular abstract data types. Moreover, implementation of protecting software transmitted over an unprotected interface can be practiced with other computer system configurations, including hand held devices, multi processor systems, microprocessor based or programmable consumer electronics, network PCs, minicomputers, mainframe computers, and the like. Further, protection of software transmitted over an unprotected interface also can be practiced in distributed computing environments where tasks are performed by remote processing devices that are linked through a communications network. In a distributed computing environment, program modules can be located in both local and remote memory storage devices.

A computer system can be roughly divided into three component groups: the hardware component, the hardware/software interface system component, and the applications programs component (also referred to as the “user component” or “software component”). In various embodiments of a computer system the hardware component may comprise the central processing unit (CPU) 721, the memory (both ROM 764 and RAM 725), the basic input/output system (BIOS) 766, and various input/output (I/O) devices such as a keyboard 740, a mouse 762, a monitor 747, and/or a printer (not shown), among other things. The hardware component comprises the basic physical infrastructure for the computer system.

The applications programs component comprises various software programs including but not limited to compilers, database systems, word processors, business programs, videogames, and so forth. Application programs provide the means by which computer resources are utilized to solve problems, provide solutions, and process data for various users (machines, other computer systems, and/or end-users). In an example embodiment, application programs perform the functions associated with protecting software transmitted over an unprotected interface as described above.

The hardware/software interface system component comprises (and, in some embodiments, may solely consist of) an operating system that itself comprises, in most cases, a shell and a kernel. An “operating system” (OS) is a special program that acts as an intermediary between application programs and computer hardware. The hardware/software interface system component may also comprise a virtual machine manager (VMM), a Common Language Runtime (CLR) or its functional equivalent, a Java Virtual Machine (JVM) or its functional equivalent, or other such software components in the place of or in addition to the operating system in a computer system. A purpose of a hardware/software interface system is to provide an environment in which a user can execute application programs.

The hardware/software interface system is generally loaded into a computer system at startup and thereafter manages all of the application programs in the computer system. The application programs interact with the hardware/software interface system by requesting services via an application program interface (API). Some application programs enable end-users to interact with the hardware/software interface system via a user interface such as a command language or a graphical user interface (GUI).

A hardware/software interface system traditionally performs a variety of services for applications. In a multitasking hardware/software interface system where multiple programs may be running at the same time, the hardware/software interface system determines which applications should run in what order and how much time should be allowed for each application before switching to another application for a turn. The hardware/software interface system also manages the sharing of internal memory among multiple applications, and handles input and output to and from attached hardware devices such as hard disks, printers, and dial-up ports. The hardware/software interface system also sends messages to each application (and, in certain case, to the end-user) regarding the status of operations and any errors that may have occurred. The hardware/software interface system can also offload the management of batch jobs (e.g., printing) so that the initiating application is freed from this work and can resume other processing and/or operations. On computers that can provide parallel processing, a hardware/software interface system also manages dividing a program so that it runs on more than one processor at a time.

A hardware/software interface system shell (referred to as a “shell”) is an interactive end-user interface to a hardware/software interface system. (A shell may also be referred to as a “command interpreter” or, in an operating system, as an “operating system shell”). A shell is the outer layer of a hardware/software interface system that is directly accessible by application programs and/or end-users. In contrast to a shell, a kernel is a hardware/software interface system's innermost layer that interacts directly with the hardware components.

As shown in FIG. 6, an exemplary general purpose computing system includes a conventional computing device 760 or the like, including a processing unit 721, a system memory 762, and a system bus 723 that couples various system components including the system memory to the processing unit 721. The system bus 723 may be any of several types of bus structures including a memory bus or memory controller, a peripheral bus, and a local bus using any of a variety of bus architectures. The system memory includes read only memory (ROM) 764 and random access memory (RAM) 725. A basic input/output system 766 (BIOS), containing basic routines that help to transfer information between elements within the computing device 760, such as during start up, is stored in ROM 764. The computing device 760 may further include a hard disk drive 727 for reading from and writing to a hard disk (hard disk not shown), a magnetic disk drive 728 (e.g., floppy drive) for reading from or writing to a removable magnetic disk 729 (e.g., floppy disk, removal storage), and an optical disk drive 730 for reading from or writing to a removable optical disk 731 such as a CD ROM or other optical media. The hard disk drive 727, magnetic disk drive 728, and optical disk drive 730 are connected to the system bus 723 by a hard disk drive interface 732, a magnetic disk drive interface 733, and an optical drive interface 734, respectively. The drives and their associated computer readable media provide non volatile storage of computer readable instructions, data structures, program modules and other data for the computing device 760. Although the exemplary environment described herein employs a hard disk, a removable magnetic disk 729, and a removable optical disk 731, it should be appreciated by those skilled in the art that other types of computer readable media which can store data that is accessible by a computer, such as magnetic cassettes, flash memory cards, digital video disks, Bernoulli cartridges, random access memories (RAMs), read only memories (ROMs), and the like may also be used in the exemplary operating environment. Likewise, the exemplary environment may also include many types of monitoring devices such as heat sensors and security or fire alarm systems, and other sources of information.

A number of program modules can be stored on the hard disk, magnetic disk 729, optical disk 731, ROM 764, or RAM 725, including an operating system 735, one or more application programs 736, other program modules 737, and program data 738. A user may enter commands and information into the computing device 760 through input devices such as a keyboard 740 and pointing device 762 (e.g., mouse). Other input devices (not shown) may include a microphone, joystick, game pad, satellite disk, scanner, or the like. These and other input devices are often connected to the processing unit 721 through a serial port interface 746 that is coupled to the system bus, but may be connected by other interfaces, such as a parallel port, game port, or universal serial bus (USB). A monitor 747 or other type of display device is also connected to the system bus 723 via an interface, such as a video adapter 748. In addition to the monitor 747, computing devices typically include other peripheral output devices (not shown), such as speakers and printers. The exemplary environment of FIG. 6 also includes a host adapter 755, Small Computer System Interface (SCSI) bus 756, and an external storage device 762 connected to the SCSI bus 756.

The computing device 760 may operate in a networked environment using logical connections to one or more remote computers, such as a remote computer 749. The remote computer 749 may be another computing device (e.g., personal computer), a server, a router, a network PC, a peer device, or other common network node, and typically includes many or all of the elements described above relative to the computing device 760, although only a memory storage device 750 (floppy drive) has been illustrated in FIG. 6. The logical connections depicted in FIG. 6 include a local area network (LAN) 751 and a wide area network (WAN) 752. Such networking environments are commonplace in offices, enterprise wide computer networks, intranets and the Internet.

When used in a LAN networking environment, the computing device 760 is connected to the LAN 751 through a network interface or adapter 753. When used in a WAN networking environment, the computing device 760 can include a modem 754 or other means for establishing communications over the wide area network 752, such as the Internet. The modem 754, which may be internal or external, is connected to the system bus 723 via the serial port interface 746. In a networked environment, program modules depicted relative to the computing device 760, or portions thereof, may be stored in the remote memory storage device. It will be appreciated that the network connections shown are exemplary and other means of establishing a communications link between the computers may be used.

While it is envisioned that numerous embodiments of protection of software transmitted over an unprotected interface are particularly well-suited for computerized systems, nothing in this document is intended to limit the invention to such embodiments. On the contrary, as used herein the term “computer system” is intended to encompass any and all devices capable of storing and processing information and/or capable of using the stored information to control the behavior or execution of the device itself, regardless of whether such devices are electronic, mechanical, logical, or virtual in nature.

The various techniques described herein can be implemented in connection with hardware or software or, where appropriate, with a combination of both. Thus, the methods and apparatuses for protecting software transmitted over an unprotected interface, or certain aspects or portions thereof, can take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for implementing protection of software transmitted over an unprotected interface.

The program(s) can be implemented in assembly or machine language, if desired. In any case, the language can be a compiled or interpreted language, and combined with hardware implementations. The methods and apparatuses for implementing protection of software transmitted over an unprotected interface also can be practiced via communications embodied in the form of program code that is transmitted over some transmission medium, such as over electrical wiring or cabling, through fiber optics, or via any other form of transmission, wherein, when the program code is received and loaded into and executed by a machine, such as an EPROM, a gate array, a programmable logic device (PLD), a client computer, or the like. When implemented on a general-purpose processor, the program code combines with the processor to provide a unique apparatus that operates to invoke the functionality of protecting software transmitted over an unprotected interface. Additionally, any storage techniques used in connection with protecting software transmitted over an unprotected interface can invariably be a combination of hardware and software.

While protection of software transmitted over an unprotected interface has been described in connection with the example embodiments of the various figures, it is to be understood that other similar embodiments can be used or modifications and additions can be made to the described embodiments for performing the same functions of protecting software transmitted over an unprotected interface without deviating therefrom. Therefore, protecting software transmitted over an unprotected interface as described herein should not be limited to any single embodiment, but rather should be construed in breadth and scope in accordance with the appended claims.

What is claimed:

1. A computer-implemented method for protecting software, the method comprising:
parsing a first cryptographic key into at least one component;
decrypting an encrypted second cryptographic key utilizing a first component of the at least one component;
encrypting a session key utilizing the second cryptographic key;
providing the encrypted session key;
receiving a signal indicative of an encrypted phrase, the phrase being encrypted with a decrypted version of the provided encrypted session key, the decrypted version of the provided encrypted session key being encrypted with a third cryptographic key;
decrypting the encrypted phrase with the session key for generating a decrypted phrase;
comparing the decrypted phrase with a predetermined phrase;
determining a validity of the decrypted phrase in accordance with the step of comparing; and
if the decrypted phrase is determined to be valid, allowing communication of the software.

2. A method in accordance with claim 1, wherein the second cryptographic key is identical to the third cryptographic key.

3. A method in accordance with claim 1, further comprising, if the decrypted phrase is determined to be valid, allowing communication of the software in accordance with a digital rights management scheme.

4. A method in accordance with claim 3, wherein the digital rights management scheme is conformation with Advanced Access Content System digital rights management scheme.

5. A method in accordance with claim 4, wherein:
the digital rights management scheme is conformation with Advanced Access Content System digital rights management scheme; and
the at least one digital rights management key comprises at least one of a device key and a sequence key.

6. A method in accordance with claim 1, wherein the software is communicated between a game console and a peripheral device.

7. A method in accordance with claim 1, wherein the software comprises media content.

8. A system for protecting software, the system comprising:
a processing portion configured to:
parse a first cryptographic key into at least one component;
decrypt an encrypted second cryptographic key utilizing a first component of the at least one component;
encrypt a session key utilizing the second cryptographic key;
decrypt an encrypted phrase with the session key for generating a decrypted phrase;
compare the decrypted phrase with a predetermined phrase;
determine a validity of the decrypted phrase in accordance with the step of comparing; and
if the decrypted phrase is determined to be valid, allow communication of the software; and
an input/output portion configure to:
provide the encrypted session key; and
receive a signal indicative of the encrypted phrase, the phrase being encrypted with a decrypted version of the provided encrypted session key, the decrypted version of the provided encrypted session key being encrypted with a third cryptographic key;

9. A system in accordance with claim 8, wherein the second cryptographic key is identical to the third cryptographic key.

10. A system in accordance with claim 8, the processing portion further configured to, if the decrypted phrase is determined to be valid, allow communication of the software in accordance with a digital rights management scheme.

11. A system in accordance with claim 10, wherein the digital rights management scheme is conformation with Advanced Access Content System digital rights management scheme.

12. A system in accordance with claim 11, wherein:
the digital rights management scheme is conformation with Advanced Access Content System digital rights management scheme; and
the at least one digital rights management key comprises at least one of a device key and a sequence key.

13. A system in accordance with claim 8, wherein the software is communicated between a game console and a peripheral device.

14. A system in accordance with claim 8, wherein the software comprises media content.

15. A system in accordance with claim 8, wherein:
the software comprises media content; and
the media content is communicated between a game console and a peripheral device configured to play HD DVD formatted media.

16. A computer-readable medium having stored thereon computer-executable instructions for protecting software by performing the steps of:
parsing a first cryptographic key into at least one component;
decrypting an encrypted second cryptographic key utilizing a first component of the at least one component;
encrypting a session key utilizing the second cryptographic key;
providing the encrypted session key;
receiving a signal indicative of an encrypted phrase, the phrase being encrypted with a decrypted version of the provided encrypted session key, the decrypted version of the provided encrypted session key being encrypted with a third cryptographic key;
decrypting the encrypted phrase with the session key for generating a decrypted phrase;
comparing the decrypted phrase with a predetermined phrase;
determining a validity of the decrypted phrase in accordance with the step of comparing; and
if the decrypted phrase is determined to be valid, allowing communication of the software.

17. A computer-readable medium in accordance with claim 16, wherein the second cryptographic key is identical to the third cryptographic key.

18. A computer-readable medium in accordance with claim 16, the computer-executable instruction further for, if the decrypted phrase is determined to be valid, allowing communication of the software in accordance with a digital rights management scheme.

19. A computer-readable medium in accordance with claim 18, wherein the digital rights management scheme is conformation with Advanced Access Content System digital rights management scheme.

20. A computer-readable medium in accordance with claim 19, wherein:
the software comprises media content; and
the media content is communicated between a game console and a peripheral device configured to play HD DVD formatted media;
the digital rights management scheme is conformation with Advanced Access Content System digital rights management scheme; and
the at least one digital rights management key comprises at least one of a device key and a sequence key.
